(19) United States
(12) Patent Application Publication
(10) Pub. No.: US 2016/0127842 A1
(43) Pub. Date: May 5, 2016

(54) METHOD FOR OPERATING A HEARING SYSTEM AND A DEVICE OF A HEARING SYSTEM

(71) Applicant: SONOVA AG, Stäfa (CH)

(72) Inventors: David Perels, Zurich (CH); Christian Fischlin, Winznau (CH)

(21) Appl. No.: 14/897,791

(22) PCT Filed: Jun. 13, 2013
(86) PCT No.: PCT/EP2013/062281

§ 371 Date: Dec. 11, 2015

(51) Int. Cl. H04R 25/00

(52) U.S. Cl. CPC H04R 25/505; H04R 25/552; H04R 25/305; H04R 2225/41

(57) ABSTRACT

A method for operating a hearing system with at least a first device and a second device. The method includes the steps of booting of the first device, sending a state query from the first device to the second device, sending a state response from the second device to the first device, the state response including information regarding an operational state of the second device, and adjusting the operational state of the first device dependent on the state response. A device can be employed to perform such a method as part of the hearing system. The hearing system can for instance be a binaural hearing system, a CROS system or a system including a hearing device and a fitting device for adjusting the hearing device to the individual requirements of the hearing device user.

### TECHNICAL FIELD

The present invention pertains to a method for operating a hearing system as well as to a device adapted to perform such a method as part of the hearing system.

### BACKGROUND OF THE INVENTION

Hearing systems are common place nowadays for delivering audio signals to one or both ears of a user, whereby the audio signals are typically processed by the hearing system so as for instance to increase audio quality, e.g. by suppressing undesirable interference, or to enhance the audio signal, in order to improve the hearing capability especially of hearing impaired users, e.g. by amplifying the audio signal in frequency bands where the user exhibits a hearing loss. Such hearing systems typically consist of one or two miniature hearing devices worn at one or both ears or at least partly within one or both ear canals of the user, often times together with a further auxiliary device (sometimes referred to as a hearing device accessory) providing certain additional functionality to the hearing system such as for instance the ability to control or program the hearing system or to connect with further devices so as to enable communication with or access to the hearing system. Well-known examples are binaural and CROS (contralateral routing of signals) hearing systems where two hearing devices, one worn at the left and the other worn at the right ear of a user, are connected together preferably via a wireless link. In a binaural hearing system audio signals and/or control signals are bi-directionally exchanged between the ipsi-lateral and the contralateral hearing devices such as for instance disclosed in WO 99/43185 A1 and EP 1 326 478 A2. In the case of a CROS system the audio signal picked up by a microphone at the ear with worse hearing capability is transmitted to the contralateral ear with better hearing capability in order to overcome the sound shadowing effect of the head (see e.g. Harvey Dillon, Hearing Aids, Thieme, 2001, Section 16.1).

EP 0 941 014 A2 describes a binaural hearing system where the control signal generated by a control element located at a first hearing aid mounted at one ear of a user is transmitted to a second hearing aid mounted at the other ear of the user in order to simultaneously adapt the second hearing aid in the same way as the first hearing aid.

WO 00/00001 A2 discloses a binaural hearing system where control signals are bi-directionally transmitted between the ipsi-lateral and the contralateral hearing devices, wherein the control signals include information for synchronising or pairing the operational modes of the two devices. Synchronised or paired operation means that either both devices are put (based on the control signals) in the same operational mode or more generally, that the second device adopts (based on the control signals) a mode of operation which corresponds to the second mode of a mode pair, when the first device is operating according to the first mode of the mode pair.

EP 1 619 929 A2 a further binaural hearing system where the synchronisation of parameters or control signals is at least partially inhibited in the case where one hearing device is operating in “audio reception” mode, i.e. where only one of the two hearing devices is equipped with an audio-shoe for receiving an remote audio signal. Here it would not make sense to operate both devices in a synchronised manner in the “audio reception” mode, since only one hearing device is actually receiving a remote audio signal. This situation could in fact be handled by the binaural hearing system according to WO 00/00001 A2 by applying a specific mode pair, e.g. called “audio reception”, i.e. an associated “binaural system mode” to the two devices of the binaural system, for instance consisting of operating the device with the audio-shoe in “audio-shoe reception” mode and operating the second device in a compatible, but different mode.

The prior art thus teaches to exchange control signals between the devices of a binaural system in order to adjust, e.g. align the state or mode of operation of the individual devices. A problem that arises with this kind of mechanism is that a new device joining the hearing system or a device belonging to the hearing system, which has been forced to reboot after a failure, or which has booted after exchanging a battery might well disrupt the overall operation of the hearing system, e.g. lead to an inconsistent hearing system because the (re-)booted device does not fit into the current operation of the rest of the hearing system. In cases where a reboot occurs as a result of a device error the previous operational mode/state should be re-established without relying on any information stored in the non-volatile memory (NVM) since this information may have been corrupted and data integrity may have been compromised. Furthermore, the user should not have to take any action to resynchronise the device which has booted. Ideally, the user should barely notice that a reboot has taken place and therefore, the device is required to establish an appropriate operational state/mode as quickly as possible. An example of inconsistent device behaviour for instance occurs during fitting, e.g. of a CROS hearing system, where following programming or downloading of appropriate hearing device settings the hearing device which has been updated is forced to reboot. Following rebooting the device however immediately assumes a mode of operation where it transmits the audio signal picked up by the microphone to the contralateral hearing device instead of re-joining the on-going fitting session for instance to await further commands from the fitting device.

### SUMMARY OF THE INVENTION

It is an object of the present invention to provide an improved method for operating a hearing system as well as to provide a device capable of performing such a method as part of the hearing system, which allows simple and automatic addition or re-joining of a device to the hearing system without user intervention.

The object stated above is achieved by a method for operating a hearing system with at least a first device and a second device, said method comprising the steps of:
booting of the first device;
sending a state query from the first device to the second device;
sending a state response from the second device to the first device, said state response comprising information regarding an operational state of the second device; and
adjusting the operational state of the first device dependent on the state response.

In an embodiment of the method the step of adjusting includes deriving the operational state of the first device from a look-up table containing a plurality of state vectors, each related to a valid operational state of at least the first device and the second device.

In a further embodiment of the method the step of adjusting includes deriving the operational state of the first device dependent on information pertaining to the momentary acoustic situation, for instance provided by an acoustic scene classifier, the classifier for instance being part of the first device.

In a further embodiment of the method the step of booting is preceded by one of the following steps:
replacing a battery of the first device;
resetting the first device;
triggering a reset of the first device by a watchdog timer/unit;
triggering a reset of the first device by a power glitch detector.

Power glitches (i.e. brief current and voltage drops) occur when units which consume a comparatively large amount of power such as a wireless transceiver or an NVM are switched on. If the duration of such a power glitch exceeds a certain length of time the hearing device assumes that the battery is too weak and will typically be shut down. On the other hand, when a power glitch detector determines that a power glitch is short than a certain critical length of time it is assumed that the battery still has sufficient power capacity to operate the hearing device in a lower power mode. Therefore, instead of shutting down the hearing device, the power glitch detector triggers a reset upon which the hearing device will enter into the lower power mode.

In a further embodiment of the method the state query comprises information regarding a cause or an action leading to the step of booting of the first device.

A further embodiment of the method further comprises the step of storing in the second device the number of state queries sent by the first device and/or information regarding the cause or the action leading to the step of booting of the first device.

A further embodiment of the method further comprises the step of evaluating by the second device the stored number of state queries sent by the first device and/or the information regarding the cause or the action leading to the step of booting of the first device.

A further embodiment of the method further comprises the step of including in the state response at least one instruction to the first device regarding the step of adjusting the operational state of the first device, said at least one instruction being dependent on the step of evaluating.

In a further embodiment of the method the at least one instruction causes the first device to enter an inactive state, wherein the inactive state in particular prevents the first device from generating sound.

A further embodiment of the method further comprises the step of outputting by the second device an acoustic signal, in particular a voice message, indicating that the first device is not operating correctly.

In a further embodiment of the method the first device and the second device are each a different one of the following:
a first hearing device, more particularly an ipsi-lateral hearing device, even more particularly an ipsi-lateral hearing aid;
a second hearing device, more particularly a contralateral hearing device, even more particularly a contralateral hearing aid;
a remote control unit;
a remote processing unit;
a remote microphone unit;
an audio streaming unit;
a communication interface unit;
a fitting device.

In a further embodiment of the method the hearing system is a binaural hearing system or a CROS hearing aid system.

A further embodiment of the method further comprises the steps of:
sending at least one further state query from the first device to at least one further device;
sending a further state response from the at least one further device to the first device, said further state response comprising information regarding the operational state of the at least one further device;
adjusting the operational state of the first device further dependent on the further state response of the at least one further device.

In a further embodiment of the method the at least one further device is a different one from the first and second device selected from the above mentioned list of possible devices.

The present invention further provides a device capable of performing such a proposed method as part of the hearing system, the device comprising:
a transmitter configured to send, upon booting of the device, a state query to at least a second device of the hearing system;
a receiver configured to receive at least a state response comprising information regarding at least an operational state of at least the second device; and
an adjustment (or control) means configured to adjust the operational state of the device dependent on at least the state response of the second device.

In a further embodiment the device further comprises a look-up table containing a plurality of state vectors, each related to a valid operational state of at least the device and the second device.

In a further embodiment the device further comprises an acoustic scene classifier configured to derive information pertaining to the momentary acoustic situation, the adjustment (or control) means being further configured to adjust the operational state of the device dependent on the information pertaining to the momentary acoustic situation.

In a further embodiment of the device the state query comprises information regarding a cause or an action leading to booting of the device.

In a further embodiment of the device the state response includes at least one instruction to the device regarding adjusting the operational state of the device.

In a further embodiment of the device the at least one instruction is structured to cause the device to enter an inactive state, wherein the inactive state in particular prevents the device from generating sound.

In a further embodiment of the device the receiver is further configured to receive an incoming state query from at least the second device, and the transmitter is further configured to send at least an outgoing state response comprising information regarding at least an operational state of the device.

In a further embodiment the device further comprises a memory unit for individually storing the number of incoming state queries sent by each of the at least second device and/or information regarding the cause or the action leading to booting of the at least second device.

In a further embodiment the device further comprises an evaluation means configured to evaluate the stored number of incoming state queries sent by each of the at least second device and/or the information regarding the cause or the action leading to booting of the at least second device.

In a further embodiment of the device the outgoing state response further comprises at least one outgoing instruction to the at least second device regarding adjusting the operational state of the at least second device, said at least one outgoing instruction being determined by the evaluation means.

In a further embodiment the device further comprises a signalling means configured to output an acoustic signal, in particular a voice message, indicative of the fact that the at least second device is not operating correctly.

In a further embodiment of the device, the device is one of the following:
a first hearing device, more particularly an ipsi-lateral hearing device, even more particularly an ipsi-lateral hearing aid;
a second hearing device, more particularly a contralateral hearing device, even more particularly a contralateral hearing aid;
a remote control unit;
a remote processing unit;
a remote microphone unit;
an audio streaming unit;
a communication interface unit;
a fitting device,
   and the second device is a different one from this list than the device.

In a further embodiment the device is part of a binaural hearing system or a CROS hearing aid system.

It is pointed out that combinations of the above-mentioned embodiments give rise to even further, more specific embodiments according to the present invention.

### BRIEF DESCRIPTION OF THE DRAWINGS

The present invention is further explained below by means of non-limiting specific embodiments and with reference to the accompanying drawings. What is shown in the figures is the following:

FIG. 1 schematically depicts a block diagram of an exemplary binaural hearing system capable of performing the method according to the present invention;

FIG. 2 schematically depicts a block diagram of a further exemplary hearing system, including a plurality of further devices, capable of performing the method according to the present invention;

FIG. 3 schematically depicts a block diagram of an exemplary device capable of performing the method according to the present invention as part of the hearing system illustrated in FIGS. 1 & 2; and

FIG. 4 presents an exemplary flow chart of an embodiment of the method according to the present invention.

In these figures, like references correspond to like elements.

### DETAILED DESCRIPTION OF THE INVENTION

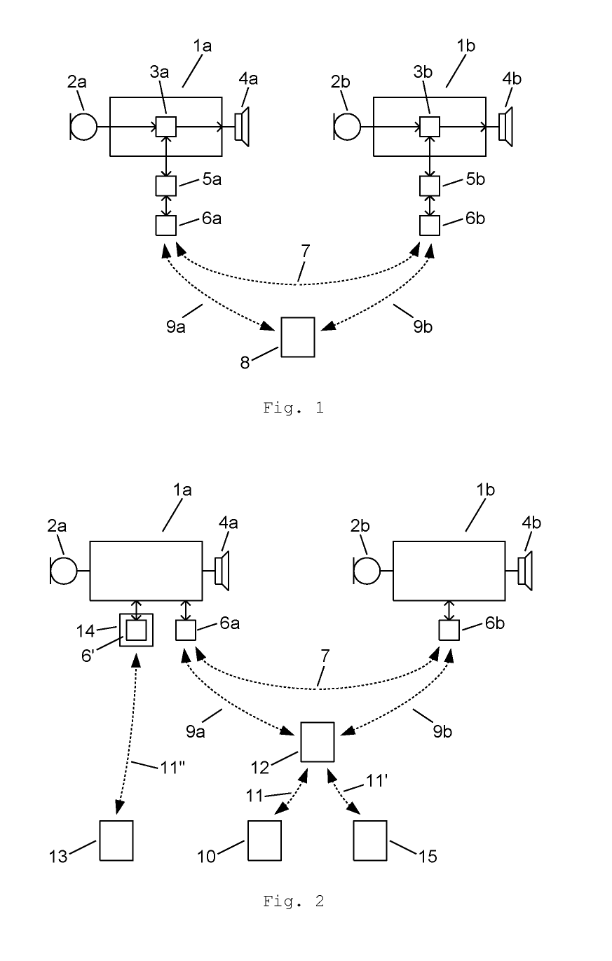

FIG. 1a schematically shows a block diagram of a binaural hearing system comprising two hearing devices 1a (ipsi-lateral) and 1b (contralateral) of identical type for being worn at the left and right ear or at least partly within the ear canals of a user of the binaural hearing system. Each hearing device 1a, 1b comprises at least one microphone (mechanical/electrical transducer) 2a, 2b, a signal processing unit 3a, 3b, a miniature loudspeaker (electrical/mechanical transducer) 4a, 4b, a control unit (also referred to as adjustment means) 5a, 5b and a receiver/transmitter unit (transceiver) 6a, 6b.

Audio signals, which are picked up by the microphones 2a, 2b, are fed—in the case of a digital hearing device via an analogue-to-digital converter (not shown in FIG. 1)—to the signal processing unit 3a, 3b, in which a transfer function corresponding to a selected hearing program is applied to the input signal in order to generate an output signal that is fed to the miniature loudspeaker 4a, 4b, if need be, via a digital-to-analogue converter (not shown in FIG. 1). For example, a desired hearing program is selected via the control unit 5a, 5b, e.g. via a switch at one of the hearing devices 1a, 1b or via a software routine that implements a classifier (16a) to automatically determine a momentary acoustic situation by analysing an acoustic signal captured by one or more of the microphones 2a, 2b. If need be, information is transmitted via the receiver/transmitter unit 6a or 6b, respectively, to the other hearing device 1a or 1b, respectively, either directly (via the wireless link 7) or via an external unit (e.g. a device such as Phonak's iCom). The external unit 8 has the function of being able to provide a stable and sustainable wireless link 9a, 9b (e.g. an inductive link), between the two hearing devices 1a, 1b amongst various other possible functions. Other functions implemented in the external unit 8 may be one or more of the following:
remote control with control means, such as switches, to control the hearing system, e.g. to override automatic settings by manual settings, or vice versa;
display to show the hearing device user an internal status of one or both hearing devices 1a, 1b;
data logging: information of the two hearing devices 1a, 1b can be logged in a large storage unit provided in the external unit 8;
additional microphone.

The information transmitted via the wireless link 7 or 9a, 9b, respectively, can be one or more of the following:
an acoustic signal captured by one or both of the microphones 2a, 2b;
acoustic parameters of the acoustic signal, such as, for example, sound level, frequency spectra, modulation frequency, modulation depth, level of noise or spatial characteristics;
user control settings, such as volume;
activity levels of one or more of the hearing system functionalities, i.e. beamformer, noise canceller, etc.;
type of algorithms, e.g. hearing program being used.

The spatial characteristics of the acoustic situation can in turn include the coherence, incident directions of noise signals, the incident direction of the useful signal, etc.

It has already been mentioned that the two hearing devices 1a, 1b of a prior art binaural hearing system are synchronised via the wireless link 7. As a result of the synchronisation, the two hearing devices are always in a pre-selectable mode-pair. Therefore, the term “synchronization” means that both hearing devices are forced to operate in one of a plurality of pre-selectable mode-pairs. The mode-pair to be active is either selected manually by the hearing system user or automatically, e.g. by the control unit 5a, 5b of one of the hearing devices 1a, 1b. There are use cases for the binaural hearing system in which it is best to operate both hearing devices 1a, 1b in the same mode, e.g. have both execute the same hearing program, i.e. have them behave “symmetrically”. In these situations the two modes of a mode-pair are identical. In other situations it is better to operate the two hearing devices 1a, 1b in different modes, e.g. employ divergent signal processing settings in the two hearing devices 1a, 1b, i.e. have them behave “asymmetrically”. In these situations the two modes of a mode-pair are not the same. A plurality of different mode-pairs is programmed into the hearing devices 1a, 1b during fitting of the binaural hearing system, i.e. when adjusting it to the individual needs of the user.

FIG. 2 schematically shows a block diagram of a further hearing system configuration again including two hearing devices 1a, 1b but this time further comprising an audio streaming unit 10, a communication interface unit 12 (e.g. a device such as Phonak's iCom), a remote microphone unit 13, and a fitting device 15. With this configuration both situations can be illustrated where “symmetrical” (i.e. identical) processing is employed at both hearing devices 1a, 1b, as well as cases where “asymmetrical” (i.e. different) operation is used. When the user would like to listen to music, e.g. from a portable music player, i.e. the audio streaming unit 10, both hearing devices 1a, 1b should be operated in the same mode, namely the one dedicated to receiving an external audio stream, e.g. transferred from the audio streaming unit 10 via the communication interface unit 12 to the hearing devices 1a, 1b using the wireless links 11 (e.g. a Bluetooth link) and 9a, 9b (e.g. inductive links), where in the case of a stereo audio signal for instance the wireless link 9a is assigned to the left audio channel and wireless link 9b is assigned to the right audio channel. Conversely, in a situation where an audio signal from a remote microphone unit 13 is wirelessly transmitted via a wireless link 11″ (e.g. a digital modulation (DM) or analogue frequency modulation (FM) link) to an audio shoe 14 comprising an receiver 6′ (e.g. for receiving frequency modulated signals) connected to only one of the hearing devices 1a, 1b, one hearing device 1a needs to be operated in a mode for receiving the audio signal from the remote microphone unit 13 whilst the microphone signal of the other hearing device 1b might for instance be muted or at least attenuated, so that the user can focus his attention on the audio signal from the remote microphone unit 13. Similarly, when the user wants to make a phone call, once the phone (not shown) is held against one of the user's ears, the hearing device at that ear should for instance pick up the sound from the phone's loudspeaker and transmit it to the other hearing device, where the microphone signal is again muted or at least attenuated so that the audio signal from the phone is provided to both ears simultaneously in order to provide the best possible speech intelligibility whilst reducing the level of interference from sound sources in the surroundings of the user. Hence, the two hearing devices 1a, 1b are operated asymmetrically in the latter two situations. Furthermore, the two hearing devices 1a, 1b can be connected to a fitting device 15 via the wireless links 11′ and 9a, 9b, over which hearing device firmware and/or hearing device parameters (e.g. hearing programs) individually adapted to the requirements and preferences of the hearing system user can be uploaded to the hearing devices 1a, 1b. Moreover, data logged in the hearing devices 1a, 1b or a large storage unit (not shown) provided in the communication interface unit 12 (or the external unit 8) can be downloaded to the fitting device 15 for analysis for instance by a fitter, in order to further improve the hearing device parameters.

In all these situations correct operation of the two hearing devices according to the most appropriate mode-pair for the use case at hand is ensured by mode changes being communicated between the two hearing devices 1a, 1b of FIG. 1, i.e. one hearing device changing its mode of operation, sending this information to the other hearing device, and the other hearing device adapting its operation to the other hearing device based on the corresponding mode-pair. If the hearing system comprises further devices (e.g. 10, 12, 13, 15) such as illustrated in FIG. 2 the mode changes of individual devices of the hearing system should likewise be communicated to the other devices within the hearing system.

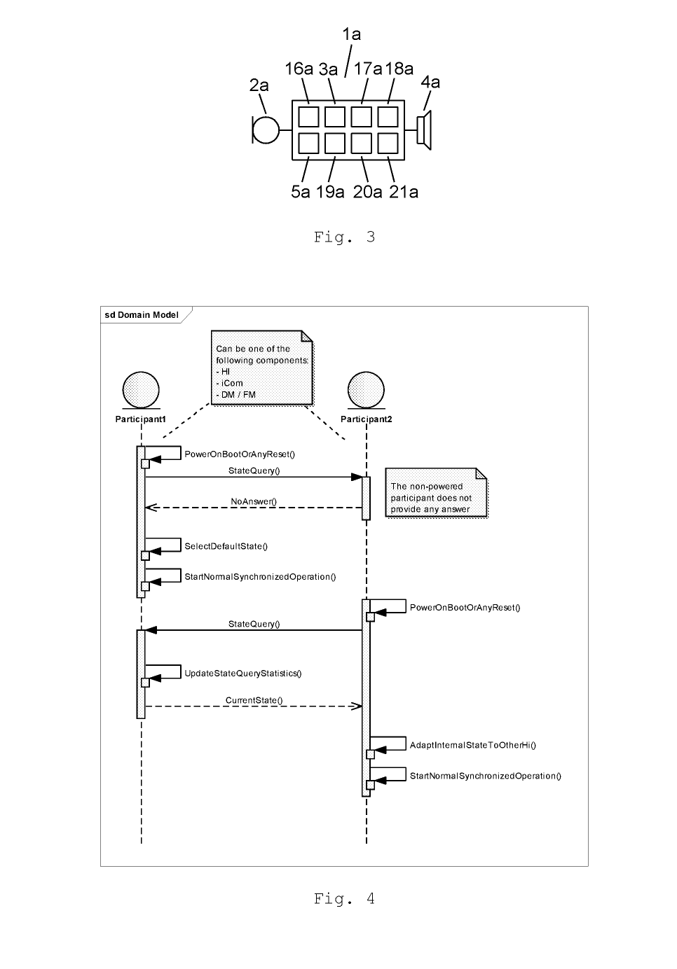

However, when for instance an error occurs in one hearing device 1a, a reset may be triggered by a watchdog unit 17a, which then causes the hearing device 1a to reboot (cf. FIG. 3 illustrating various blocks within the hearing device). In order to recover from this error the hearing device 1a needs to re-establish its previous state of operation as quickly as possible. In order to do so the hearing device 1a for instance follows the sequence of steps outlined in the following and depicted in the flow chart presented in FIG. 4 for achieving device state resynchronisation:
Initially, Participant1, e.g. a hearing device (HI 1a, 1b) or other hearing system component (iCom 8, 12; DM/FM 13), performs a power-on boot procedure (PowerOnBootOrAnyReset).
The booted Participant1 wants to synchronise its mode of operation with another device Participant2 active within the hearing system. Therefore, Participant1 sends a state query (StateQuery) to Participant2, i.e. asks Participant2 for its current mode settings (CurrentState).
Participant2 answers with its current state if it is fully booted. If not, there is no answer. Receiving no answer (NoAnswer) the sender Participant1 assumes that there is no other active device and therefore selects its default state (SelectDefaultState) and starts with its default behaviour or resumes the operation that was running before (re-)booting (StartNormalSynchronizedOperation). Participant1 possibly plays a user notification, e.g. employing the signalling means 21a, but this is not required.
Participant2 wants to synchronise with another active device Participant1 after a later start or a sudden reset leading to an unexpected reboot procedure. Hence, Participant2 sends a state query (StateQuery) to Participant1 to request its current mode settings (CurrentState).
Participant1 updates the number of state queries received from Participant2 (UpdateStateQueryStatistics) using the evaluation means 20a and storing the result in the memory unit 19a.
Participant1 sends its current settings (CurrentState) to Participant2. The rebooted device Participant2 uses the received state information to adapt the internal settings to the current hearing system state (AdaptInternalStateToOtherHi), e.g. by means of the look-up table 18a. Participant2 possibly plays a user notification, e.g. employing the signalling means 21a, but this is not required.
CurrentState may include information regarding the cause of a reset for statistical purposes. The evaluation means 20a gathers statistical information about the number of state queries of the other participants and the corresponding reset causes (UpdateStateQueryStatistics) and stores the corresponding data in the memory unit 19a. Appropriate action is taken if needed, for instance:
   Play a voice message suggesting to go to the fitter's place in case of too many queries assuming that the other participant has a problem.
   Prevent the other participant from getting active to prevent possible MPO (maximum power output) violations.

In this way the other participants can gather information regarding the system health state based on the number of state queries. Too many state queries may point to a possible problem of the requesting participant. A device of the hearing system may then decide to take an action towards the device exhibiting a problem.

Another problematic case arises after normal reboots due to battery exchanges. They may lead to inconsistent hearing systems as the rebooting participant does not respect the currently active use case, i.e. operation state of the other devices in the hearing system. The same procedure as described above can be applied in this situation.

It is clear from the preceding description that the device that has booted or rebooted does not merely wait for information from the other devices regarding their current state of operation but actively sends a query to the other devices of the hearing system. In this way it is also possible for the booted/rebooted device to determine which other devices are active within the hearing system. Moreover, the other devices of the hearing system can detect potentially faulty devices based on the number of state queries they are sending.

In conclusion, the proposed method according to the present invention helps to synchronise the devices participating in a hearing system after a reboot, which has not been supported by prior art hearing devices resulting in inconsistent hearing system states. Thanks to the inventive method the user might not even notice the reboot of a device. The benefits of the present invention can thus be summarised as enabling an always synchronised hearing system with a silent (i.e. not noticeable by the user) recovery mechanism that uses all available information in the whole hearing system. The users of hearing systems applying the inventive method will thus have a better impression of the hearing system as it offers a more consistent system state. Moreover, interruptions of fitting sessions caused by a rebooting participant can be avoided because the rebooting device employing the present invention respects the current fitting state of the other participants, and thus joins the fitting session.

What is claimed is:

1. A method for operating a hearing system with at least a first device (1a) and a second device (1b), said method comprising the steps of:
booting of the first device (1a);
sending a state query from the first device (1a) to the second device (1b);
sending a state response from the second device (1b) to the first device (1a), said state response comprising information regarding an operational state of the second device (1b); and
adjusting the operational state of the first device (1a) dependent on the state response.

2. The method of claim 1, wherein the step of adjusting includes deriving the operational state of the first device (1a) from a look-up table containing a plurality of state vectors, each related to a valid operational state of at least the first device (1a) and the second device (1b).

3. The method of claim 1, wherein the step of adjusting includes deriving the operational state of the first device (1a) dependent on information pertaining to the momentary acoustic situation, for instance provided by an acoustic scene classifier (16a), the classifier (16a) for instance being part of the first device (1a).

4. The method of claim 1, wherein the step of booting is preceded by one of the following steps:
replacing a battery of the first device (1a);
resetting the first device (1a);
triggering a reset of the first device (1a) by a watchdog unit (17a);
triggering a reset of the first device (1a) by a power glitch detector.

5. The method of claim 1, wherein the state query comprises information regarding a cause or an action leading to the step of booting of the first device (1a).

6. The method of claim 1, further comprising the step of storing in the second device (1b) the number of state queries sent by the first device (1a) and/or information regarding the cause or the action leading to the step of booting of the first device (1a).

7. The method of claim 6, further comprising the step of evaluating by the second device (1b) the stored number of state queries sent by the first device (1a) and/or the information regarding the cause or the action leading to the step of booting of the first device (1a).

8. The method of claim 7, further comprising the step of including in the state response at least one instruction to the first device (1a) regarding the step of adjusting the operational state of the first device (1a), said at least one instruction being dependent on the step of evaluating.

9. The method of claim 8, wherein the at least one instruction causes the first device (1a) to enter an inactive state, wherein the inactive state in particular prevents the first device (1a) from generating sound.

10. The method of claim 7, further comprising the step of outputting by the second device (1b) an acoustic signal, in particular a voice message, indicating that the first device (1a) is not operating correctly.

11. The method of claim 1, wherein the first device and the second device are each a different one of the following:
a first hearing device (1a), more particularly an ipsi-lateral hearing device (1a), even more particularly an ipsi-lateral hearing aid (1a);
a second hearing device (1b), more particularly a contralateral hearing device (1b), even more particularly a contralateral hearing aid (1b);
a remote control unit (8);
a remote processing unit (8);
a remote microphone unit (13);
an audio streaming unit (10);
a communication interface unit (12);
a fitting device (15).

12. The method of claim 1, wherein the hearing system is a binaural hearing system or a CROS hearing aid system.

13. The method of claim 1, further comprising the steps of:
sending at least one further state query from the first device (1a) to at least one further device (8, 10, 12, 13, 15);
sending a further state response from the at least one further device (8, 10, 12, 13, 15) to the first device (1a), said further state response comprising information regarding the operational state of the at least one further device (8, 10, 12, 13, 15);
adjusting the operational state of the first device (1a) further dependent on the further state response of the at least one further device (8, 10, 12, 13, 15).

14. The method of claim 13, wherein the at least one further device is a different one from the first and second device selected from
a first hearing device (1a), more particularly an ipsi-lateral hearing device (1a), even more particularly an ipsi-lateral hearing aid (1a);
a second hearing device (1b), more particularly a contralateral hearing device (1b), even more particularly a contralateral hearing aid (1b);
a remote control unit (8);
a remote processing unit (8);
a remote microphone unit (13);
an audio streaming unit (10);
a communication interface unit (12);
a fitting device (15).

15. A device (1a, 1b) of a hearing system comprising:
a transmitter (6a, 6b) configured to send, upon booting of the device (1a, 1b), a state query to at least a second device (1b, 1a) of the hearing system;
a receiver (6a, 6b) configured to receive at least a state response comprising information regarding at least an operational state of at least the second device (1b, 1a); and
an adjustment means (5a, 5b) configured to adjust the operational state of the device (1a, 1b) dependent on at least the state response of the second device (1b, 1a).

16. The device (1a, 1b) of claim 15, further comprising a look-up table (18a) containing a plurality of state vectors, each related to a valid operational state of at least the device (1a, 1b) and the second device (1b, 1a).

17. The device (1a, 1b) of claim 15, further comprising an acoustic scene classifier (16a) configured to derive information pertaining to the momentary acoustic situation, the adjustment means (5a, 5b) being further configured to adjust the operational state of the device dependent on the information pertaining to the momentary acoustic situation.

18. The device (1a, 1b) of claim 15, wherein the state query comprises information regarding a cause or an action leading to booting of the device (1a, 1b).

19. The device (1a, 1b) of claim 15, wherein the state response includes at least one instruction to the device (1a, 1b) regarding adjusting the operational state of the device (1a, 1b).

20. The device (1a, 1b) of claim 19, wherein the at least one instruction is structured to cause the device (1a, 1b) to enter an inactive state, wherein the inactive state in particular prevents the device (1a, 1b) from generating sound.

21. The device (1a, 1b) of claim 15, wherein
the receiver (6a, 6b) is further configured to receive an incoming state query from at least the second device (1b, 1a); and
the transmitter (6a, 6b) is further configured to send at least an outgoing state response comprising information regarding at least an operational state of the device (1a, 1b).

22. The device (1a, 1b) of claim 21, further comprising a memory unit (19a) for individually storing the number of incoming state queries sent by each of the at least second device (1b, 1a) and/or information regarding the cause or the action leading to booting of the at least second device (1b, 1a).

23. The device (1a, 1b) of claim 22, further comprising an evaluation means (20a) configured to evaluate the stored number of incoming state queries sent by each of the at least second device (1b, 1a) and/or the information regarding the cause or the action leading to booting of the at least second device (1b, 1a).

24. The device (1a, 1b) of claim 23, wherein the outgoing state response further comprises at least one outgoing instruction to the at least second device (1b, 1a) regarding adjusting the operational state of the at least second device (1b, 1a), said at least one outgoing instruction being determined by the evaluation means (20a).

25. The device (1a, 1b) of claim 23, further comprising a signalling means (21a) configured to output an acoustic signal, in particular a voice message, indicative of the fact that the at least second device (1b, 1a) is not operating correctly.

26. The device of claim 15, wherein the device is one of the following:
a first hearing device (1a), more particularly an ipsi-lateral hearing device (1a), even more particularly an ipsi-lateral hearing aid (1a);
a second hearing device (1b), more particularly a contralateral hearing device (1b), even more particularly a contralateral hearing aid (1b);
a remote control unit (8);
a remote processing unit (8);
a remote microphone unit (13);
an audio streaming unit (10);
a communication interface unit (12);
a fitting device (15),
and the second device is a different one from this list than the device.

27. The device (1a, 1b) of claim 15, is part of a binaural hearing system or a CROS hearing aid system.
